(19) United States
(12) Patent Application Publication
(10) Pub. No.: US 2005/0129818 A1
(43) Pub. Date: Jun. 16, 2005

(54) Process for producing rice sheet

(75) Inventors: Tatuya Yamamoto, Gunma (JP); Fumihiko Sano, Gunma (JP); Kouju Matsuo, Gunma (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: AJINOMOTO CO., INC., Tokyo (JP)

(21) Appl. No.: 11/008,139

(22) Filed: Dec. 10, 2004

(30) Foreign Application Priority Data
Dec. 12, 2003 (JP) 2003-414549

(51) Int. Cl. A21D 6/00

(52) U.S. Cl. 426/502

(57) ABSTRACT

A thin rice sheet with a thickness of 10 mm or less which maintains a soft and full mouthfeel and a smooth surface shape of boiled rice and has appropriate strength and flexibility is disclosed. Rice rinsed in a rice rinsing step 11 is boiled with hot water for a short period of time in a first heating step 12 to produce surface-gelatinized rice. In a dipping and draining step 13, the surface-gelatinized rice is put on a bamboo basket, immediately cooled with water, and left to stand for a few minutes to make the surface half-dry. Then, in a measuring step 14, a weight of the surface-gelatinized rice is measured for sectioning. In a shaping step 15, the sectioned surface-gelatinized rice is lightly kneaded, and then extended to form a surface-gelatinized rice sheet. In a steam heating step 17a of a second heating step 17, the surface-gelatinized rice sheet is steamed. In a hot water heating step 17b of the second heating step 17 which is performed simultaneously with the steam heating step 17a, hot water is sprinkled on the surface-gelatinized rice sheet at several minutes intervals to completely cook the surface-gelatinized rice sheet.

### BACKGROUND OF THE INVENTION

I. Field of the Invention

The present invention relates to a process for producing a rice sheet, and more specifically to a process for producing a thin rice sheet having a thickness of 10 mm or less.

II. Description of the Related Art

In recent years, by diversification of rice foods, foods obtained by shaping rice into a sheet and wrapping ingredients in the rice sheet or topping ingredients and sauce as for a pizza have been proposed.

Examples of a method for producing a rice sheet include a method for producing a rice sheet having high shape retention in which a ground paste of white fish is incorporated into cooked rice and the resulting rice is then shaped into a sheet (see, for example, JP-A-1-174349) and heated, a method in which cooked rice is thin-extended to give two layers or less and then heated to produce a rice sheet having a thickness of less than 10 mm (see, for example, JP-A-11-285351), a method for imparting a soft and full mouthfeel and appearance of cooked rice to a rice sheet in which a package is charged with rice and water, sealed so as to give a head space of a predetermined volume, and then heated to perform cooking and shaping of the rice (see, for example, JP-A-2003-38110), and the like.

However, in the method in which the ground paste of white fish is incorporated in cooked rice, rice grains were crushed or surfaces thereof were roughened in shaping rice into a sheet, lessening the mouthfeel because of stickiness provided on the surface of cooked rice. Further, since the ground paste of white fish is incorporated, taste and mouthfeel different from those of cooked rice resulted.

In the method in which cooked rice is thin-extended, shaped into a sheet and then heated, it was difficult to thin-extend cooked rice to give two layers or less. Accordingly, cooked rice had to be manually extended using a spatula or a rolling pin. For this reason, it took much labor to extend cooked rice, and productivity was low. Thus, it was hard to mass-produce the same industrially.

In the method using a package, a package corresponding to the shape of the required sheet was demanded, increasing the cost. Further, when a rice sheet of a large size was formed using a big package, the thickness of cooked rice was irregular, so that only a rice sheet of a relatively small shape was able to be formed. Moreover, when the resulting rice sheet was taken out from the package, the sheet was likely to be torn.

### SUMMARY OF THE INVENTION

Under these circumstances, the invention aims to provide a process for producing a thin rice sheet with a thickness of 10 mm or less which maintains a soft and full mouthfeel and a smooth surface shape of cooked rice and has appropriate strength and flexibility.

For accomplishing the foregoing aim, the invention is characterized by comprising a first heating step of heating raw rice with hot water or steam to obtain surface-gelatinized rice in which a surface layer portion is gelatinized and a central portion remains ungelatinized, a dipping and draining step of cooling the surface-gelatinized rice with water after the first heating step and then draining the resulting rice, a measuring step of measuring a weight of the surface-gelatinized rice for sectioning after the dipping and draining step, a shaping step of lightly kneading the surface-gelatinized rice separated in the measuring step and then shaping the resulting rice into a sheet, and a second heating step of cooking the surface-gelatinized rice sheet shaped in the shaping step. In the shaping step, starch may be added or a powdery seasoning or a foodstuff may be added to the surface-gelatinized rice.

The second heating step can be performed by a steam heating step of heating the surface-gelatinized rice sheet with steam and a hot water heating step of heating the surface-gelatinized rice sheet with hot water after the steam heating step, or by a steam heating step of heating the surface-gelatinized rice sheet with steam and a hot water heating step of heating the surface-gelatinized rice sheet by sprinkling hot water during the steam heating step. Further, the hot water in the hot water heating step may contain starch or a seasoning.

The process may further comprise a baking step of baking the surface of the rice sheet cooked in the second heating step, and before the baking step, a topping step of topping ingredients and sauce on the upper surface of the rice sheet may be performed.

In the first heating step, raw rice becomes surface-gelatinized rice whose surface layer portion is gelatinized and central portion remains ungelatinized. The surface-gelatinized rice is lightly kneaded, whereby the surface layer portion having stickiness is peeled and becomes a paste layer to bind rice grains, making it possible to easily shape the surface-gelatinized rice and thin-extend the same. Further, the surface-gelatinized rice sheet is completely cooked in the second heating step, whereby a rice sheet having a soft and full mouthfeel and a smooth surface state of boiled rice and appropriate strength and flexibility can be produced.

By shaping the surface-gelatinized rice and adding starch, the shapeability of the surface-gelatinized rice can be improved. By adding a powdery seasoning or a foodstuff to the surface-gelatinized rice during the shaping step, a seasoned rice sheet can be produced.

In the hot water heating step of the surface-gelatinized rice sheet, by incorporating starch in the hot water, the rice sheet can be reinforced. By incorporating a seasoning in the hot water, a seasoned rice sheet can be produced.

Moreover, by conducting a baking step of baking the rice sheet with an oven or an iron plate, a crisp mouthfeel can be provided. When the rice sheet is topped with ingredients and sauce before the baking step, a pizza-like food can be produced.

### BRIEF DESCRIPTION OF THE DRAWINGS

FIG. 1 is a flow chart showing a process for producing a rice sheet in Example 1;

FIG. 2 is a flow chart showing a process for producing a rice sheet in Example 2;

FIG. 3 is a flow chart showing a process for producing a rice sheet in Example 3;

FIG. 4 is a flow chart showing a process for producing a rice sheet in Example 4;

FIG. 5 is a flow chart showing a process for producing a rice sheet in Comparative Example 1;

FIG. 6 is a flow chart showing a process for producing a rice sheet in Example 5;

FIG. 7 is a flow chart showing a process for producing a rice sheet in Example 6; and

FIG. 8 is a flow chart showing a process for producing a rice sheet in Example 7.

### DETAILED DESCRIPTION OF THE PREFERRED EMBODIMENTS

The invention is illustrated specifically below by referring to Examples and Comparative Example.

### EXAMPLE 1

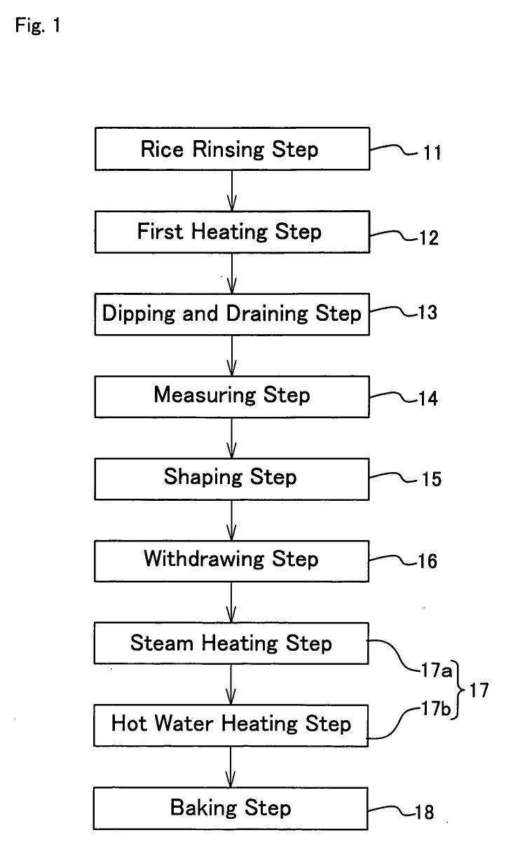

A rice sheet was produced by a process shown in FIG. 1 using 120 g of polished rice, Koshihikari from Ibaraki. First, rice was washed by a usual method in a rice rinsing step 11. Raw rice used is not particularly limited in producing region, type, quality and the like, and no-rinse rice is also available. When no-rinse rice is used, rice may be rinsed only slightly, or the rice rinsing step can be omitted.

In a first heating step 12, rice after rinsing was charged into boiled water, and heated for 1 to 1.5 minutes. Consequently, the rice is formed into surface-gelatinized rice whose a surface layer portion is gelatinized and whose central portion remains ungelatinized. When the heating time of rice is short, an ungelatinized raw portion is increased, and a cooked portion of the gelatinized surface is decreased to decrease stickiness. When the heating time is long, rice is cooked and gelatinized up to the central portion, and the surface absorbs water too much and is rendered in a gruel state. Accordingly, the heating time is preferably from 1 to 1.5 minutes.

In a dipping and draining step 13, the surface-gelatinized rice was put on a strainer, and immediately cooled with water. Then, the rice put on the strainer was left to stand for 15 minutes for draining. Consequently, the gelatinized surface portion of the surface-gelatinized rice properly absorbed water and became soft.

When the draining time is short, water absorption inside the rice grains is insufficient, and half-cooked (center portion of rice grain remains hard) rice results. When draining time is long, the surface of the surface-gelatinized rice becomes too dry. Thus, draining time is preferably from 15 to 90 minutes. In this step, the surface-gelatinized rice absorbed water, and the overall weight reached 155 g.

In a measuring step 14, the surface-gelatinized rice was measured in each amount of approximately 30 g for sectioning. This sectioned amount can optionally be selected depending on the size of the product.

In a shaping step 15, the surface-gelatinized rice separated was lightly kneaded and shaped into a ball, and then was put on a metallic petri dish having an inner diameter of 90 mm with a food package film or a cooking sheet laid on the inner surface, pressed by hand, and shaped into a round sheet having a thickness of 5 mm. In the surface-gelatinized rice, the surface layer portion which becomes sticky by absorbing water through heating, is peeled by kneading, and changed into a paste layer to bind rice grains. Further, since the central portion of the surface-gelatinized rice is in a raw rice state and tends to retain the shape, it can easily be thin-extended while retaining the shape of rice grains.

In a withdrawing step 16, the surface-gelatinized rice was placed in a petri dish and left to stand for a prescribed period of time, for example, for approximately 5 minutes for stabilization. Then, this rice was taken out from the petri dish to give a surface-gelatinized rice sheet. The surface-gelatinized rice sheet can easily be taken out (that is, withdrawn) from the petri dish along with the food package film or the cooking sheet without destroying the shape. Further, by stabilizing the surface-gelatinized rice on the petri dish for 5 minutes, rice grains are properly adhered with the paste layer. As a result, even a thin sheet having a thickness of approximately 5 mm is hardly ruptured or torn.

In a second heating step 17, a steam heating step 17a and a hot water heating step 17b were performed simultaneously. In the steam heating step 17a, the surface-gelatinized rice sheet put on a net made of a fluororesin was placed in a home steamer and cooked for approximately 25 minutes, while in the hot water heating step 17b, a small amount of hot water was sprinkled on the surface-gelatinized rice sheet at several minutes intervals. As a result, the surface-gelatinized rice sheet was in a completely cooked state to provide a rice sheet having a soft and full mouthfeel and maintaining a smooth surface state. The food package film or the cooking sheet can be peeled from the rice sheet after completing the second heating step 17.

In a baking step 18, both sides of the rice sheet were baked on a hot plate heated at 240° C. with oil thin-coated thereon for approximately 2 minutes each. Consequently, a rice sheet with a crispy mouthfeel having a weight of 43 g, a thickness of 5 mm and a diameter of approximately 115 mm after baking was obtained.

### EXAMPLE 2

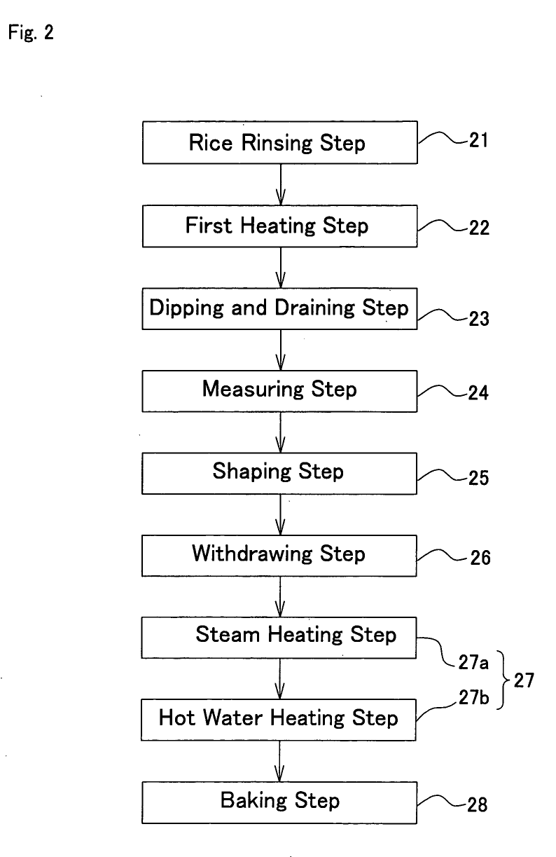

A rice sheet was produced by a process shown in FIG. 2 using 120 g of polished rice, Koshihikari from Ibaraki. In this Example, a rice rinsing step 21, a first heating step 22, a dipping and draining step 23, a measuring step 24, a shaping step 25 and a withdrawing step 26 were performed in the same manner as the rice rinsing step 11, the first heating step 12, the dipping and draining step 13, the measuring step 14, the shaping step 15 and the withdrawing step 16 in Example 1. Thus, the detailed description is omitted.

A second heating step 27 was performed by two stages, a steam heating step 27a and a hot water heating step 27b. In the first steam heating step 27a, the surface-gelatinized rice sheet was put on a net made of a fluororesin, placed in a home steamer along with the net, and steamed for approximately 15 minutes. In the next hot water heating step 27b, the rice sheet steamed in the steam heating step 27a was put on a frying pan charged shallowly with hot water, and cooked for approximately 2 minutes. The surface-gelatinized rice sheet becomes completely cooked through the steam heating step 27a and the hot water heating step 27b.

Subsequently, in a baking step 28, both sides of the cooked rice sheet were baked on a hot plate heated at 240° C. with oil thin-coated thereon for approximately 2 minutes each. Consequently, a rice sheet with a crispy mouthfeel having a weight of 41.5 g, a thickness of 5 mm and a diameter of approximately 115 mm after baking was obtained.

### EXAMPLE 3

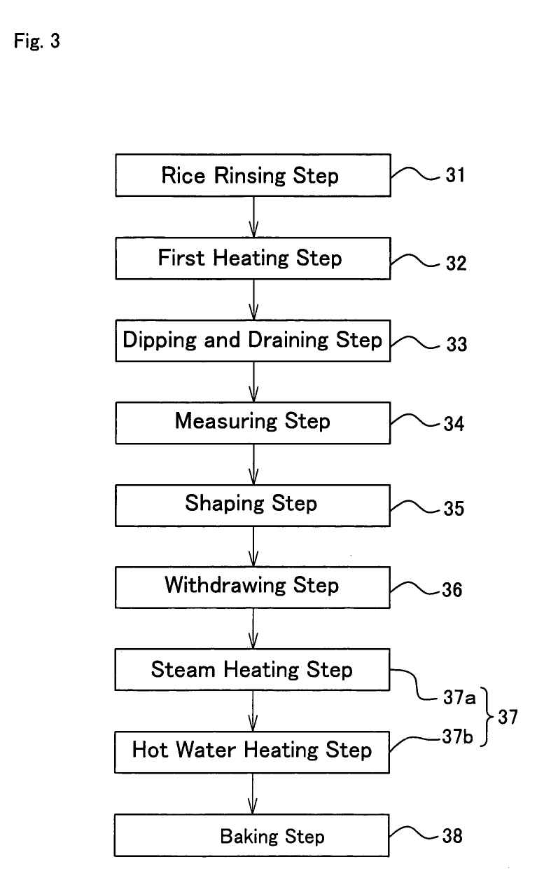

A rice sheet was produced by a process shown in FIG. 3 using 120 g of polished rice, Koshihikari from Ibaraki. In this Example, a rice rinsing step 31, a first heating step 32, a dipping and draining step 33, a measuring step 34, a shaping step 35, a withdrawing step 36 and a baking step 38 can be performed in the same manner as the rice rinsing step 11, the first heating step 12, the dipping and draining step 13, the measuring step 14, the shaping step 15, the withdrawing step 16 and the baking step 18 in Example 1.

A second heating step 37 performed after the withdrawing step 36 included a steam heating step 37a and a hot water heating step 37b. The surface-gelatinized rice sheet was put on a net made of a fluororesin, placed in a home steamer along with the net, and steamed for approximately 25 minutes. Simultaneously, hot water having dissolved joshinko (powder of nonglutinous rice) therein was sprinkled on the surface-gelatinized rice sheet at several minutes intervals. The surface-gelatinized rice sheet thereby becomes completely cooked, and rice grains are strongly adhered each other, whereby a rice sheet hard to tear can be obtained. The rice sheet with a crispy mouthfeel having a weight of 42.5 g, a thickness of 5 mm and a diameter of approximately 115 mm after baking was obtained through the baking step 38.

### EXAMPLE 4

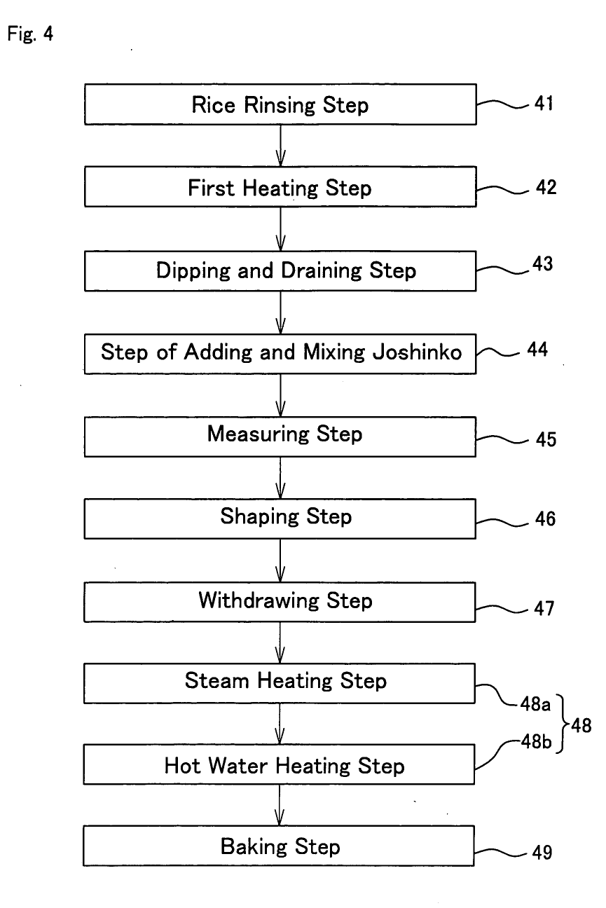

A rice sheet was produced by a process shown in FIG. 4 using 120 g of polished rice, Koshihikari from Ibaraki. In this Example, a rice rinsing step 41, a first heating step 42, and a dipping and draining step 43 were performed in the same manner as the rice rinsing step 11, the first heating step 12 and the dipping and draining step 13 in Example 1.

In a step 44 of adding and mixing joshinko, the surface-gelatinized rice was mixed with 4 g of joshinko. Then, a measuring step 45, a shaping step 46 and a withdrawing step 47 were performed in the same manner as the measuring step 14, the shaping step 15 and the withdrawing step 16 in Example 1.

In a steam heating step 48a of a second heating step 48, the surface-gelatinized rice sheet was put on a net made of a fluororesin, placed in a home steamer along with the net, and steamed for 35 minutes. Simultaneously, a small amount of hot water was sprinkled on the surface-gelatinized rice sheet at several minutes intervals in a hot water heating step 48b, and the surface-gelatinized rice sheet was completely cooked.

A baking step 49 was performed in the same manner as the baking step 18 in Example 1 to obtain a rice sheet with a crispy mouthfeel having a weight of 43 g, a thickness of 5 mm and a diameter of approximately 115 mm after baking.

### COMPARATIVE EXAMPLE 1

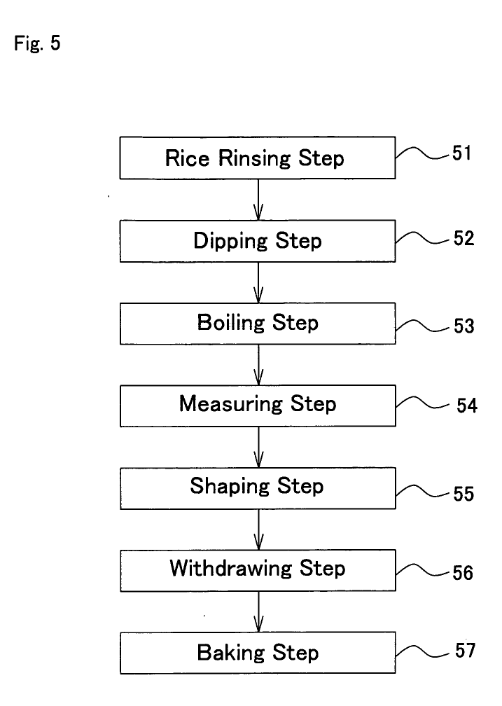

A rice sheet was produced by an ordinary process shown in FIG. 5 using 120 g of polished rice, Koshihikari from Ibaraki. In a rice rinsing step 51, rice was rinsed with water at 15° C. in a usual manner (stirring 10 times×3 times) for approximately 5 minutes. In a dipping step 52, rice after rinsed was dipped in water at 20° C. for approximately 1 hour. Subsequently, in a boiling step 53, rice after being dipped was cooked with a home rice cooker using water 1.2 times the weight of rice (total weight of rice and water charged in the rice cooker was 264 g).

In a measuring step 54, rice (approximately 225 g) after boiling was measured in an amount of approximately 45 g each for sectioning. In a shaping step 55, the sectioned rice was grasped by hand for shape retention, then put on a metallic petri dish having an inner diameter of 120 mm with a food package film or a cooking sheet laid on an inner surface, and pressed by hand into a round rice sheet having a thickness of 5 mm.

In a withdrawing step 56, the shaped rice was left to stand for approximately 5 minutes while being put on the petri dish for stabilization, and the resulting rice sheet was then taken out from the petri dish.

In a final baking step 57, both sides of the rice sheet were baked on a hot plate heated at 240° C. with oil thin-coated thereon for approximately 1 minute each to obtain a rice sheet with a crispy mouthfeel having a weight of 42 g, a thickness of 5 mm and a diameter of approximately 115 mm after baking.

The results of comparatively evaluating the rice sheets produced in Examples 1 to 4 and Comparative Example 1 are shown in Table 1.

TABLE 1

| | | | | | | Comp. |
|---|---|---|---|---|---|---|
| | | Ex. 1 | Ex. 2 | Ex. 3 | Ex. 4 | Ex. 1 |
| Appearance | Entire shape | ◯ | ◯ | ◯ | ◯ | ◯ |
| | Shape of | ◯ | ◯ | ◯ | ◯ | X |
| | rice grains | | | | | |
| Palatability | Taste | ◯ | ◯ | ◯ | ◯ | ◯ |
| | Mouthfeel | ◯ | ◯ | ◯ | ◯ | Δ |

| | | | | | |
|---|---|---|---|---|---|
| Shapeability | Δ | Δ | Δ | ◯ | X |
| Ease of Handling | Δ | Δ | Δ | ◯ | ◯ |
| after shaping | | | | | |
| Ease of Handling | Δ | Δ | ◯ | ◯ | ◯ |
| after baking | | | | | |
| Overall evaluation | ◯ to Δ | ◯ to Δ | ◯ | ◯ | X |

◯: good with no problem
Δ: slightly problematic
X: problematic

As shown in Table 1, with respect to the entire appearance, all of the rice sheets in Examples 1 to 4 and Comparative Example 1 kept a good circular shape.

Meanwhile, in the rice sheets in Examples 1 to 4, the shape of rice grains clearly remained. However, in the rice sheet in Comparative Example 1, many deformed rice grains and collapsed rice grains were observed. With respect to the palatability, all of the rice sheets in Examples 1 to 4 and Comparative Example 1 maintained a good taste of boiled rice. With respect to the mouthfeel, the rice sheets in Examples 1 to 4 maintain a soft and full mouthfeel of boiled rice, but the rice sheet in Comparative Example 1 gave a sticky mouthfeel like that of a rice cake, and was poor in mouthfeel as boiled rice grains.

With respect to the shapeability, the rice sheet in Comparative Example 1 was high in adhesion of boiled rice. It is presumed that, for example, in the industrial shaping with the use of a roller, the boiled rice adheres to the roller, which makes the shaping difficult. In the rice sheets in Examples 1 to 3, the amount of cooked rice adhered to the food package film or the cooking sheet was relatively small. Further, the rice sheet in Example 4 was lowest in adhesion amount. Thus, they were found to be appropriate for industrial use.

With respect to the ease of handling after shaping, it was found that the rice sheets in Examples 1 to 3 tended to crack after shaping, whereas the rice sheets in Example 4 and Comparative Example 1 were hard to crack and kept a good state. Further, with respect to the ease of handling after baking, it was found that the rice sheets in Examples 1 and 2 tended to crack, whereas the rice sheets in Examples 3 and 4 and Comparative Example 1 were kept in a less cracked or less broken state.

In the overall evaluation given from the foregoing results, the rice sheets in Examples 1 and 2 might crack in the steps subsequent to the shaping step, and are somewhat hard to handle, whereas the rice sheets in Examples 3 and 4 become good in quality and ease of handling by increasing the bindability of cooked rice grains with joshinko. The rice sheet in Comparative Example 1 was slightly low in quality and also low in shapeability in comparison with the rice sheets in Examples 1 to 4.

### EXAMPLE 5

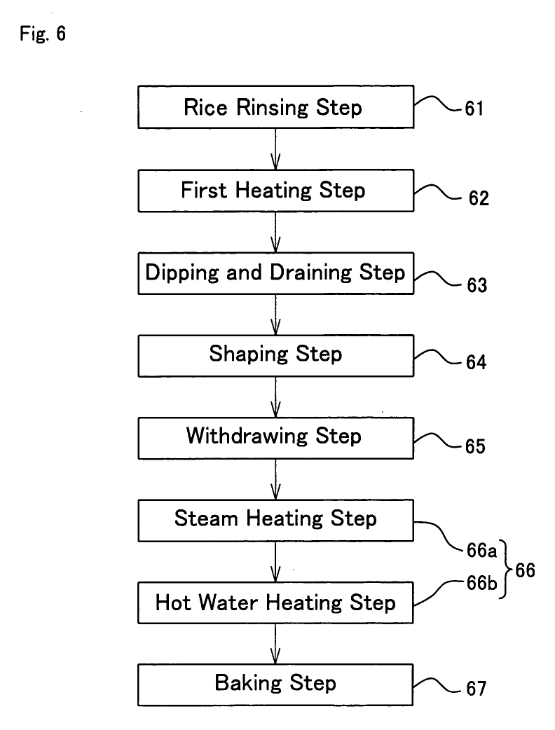

Rice sheets having various shapes were produced by a process shown in FIG. 6 using 120 g of polished rice, Koshihikari from Ibaraki. A rice rinsing step 61, a first heating step 62 and a dipping and draining step 63 were performed in the same manner as the rice rinsing step 11, the first heating step 12 and the dipping and draining step 13 in Example 1. In a shaping step 64, the surface-gelatinized rice was lightly kneaded, and shaped into a ball, which was then thin-extended to some extent while being held by hand. Subsequently, the surface-gelatinized rice was extended into a sheet up to a thickness of approximately 5 mm with a rolling pin while sprinkling joshinko as required.

In a withdrawing step 65, the sheet was punched using various confectionery dies such as a heart die, a flower die and a star die. These surface-gelatinized rice sheets were put on a net made of a fluororesin, placed in a home steamer along with the net in a steam heating step 66a of a second heating step 66, and steamed for 15 minutes. Then, in a hot water heating step 66b, the rice sheets were boiled on a frying pan charged shallowly with hot water for 2 to 3 minutes. The surface-gelatinized rice sheets were completely cooked through the steam heating step 66a and the hot water heating step 66b. Subsequently, in a baking step 67, both sides of the cooked rice sheets were baked on a hot plate heated at 240° C. with oil thin-coated thereon for approximately 1 minute each. Thus, the rice sheets with various shapes were baked.

In the resulting rice sheets, the cooked rice grains were maintained without being cracked or broken, and were good in mouthfeel. They can be used as snacks by being seasoned.

### EXAMPLE 6

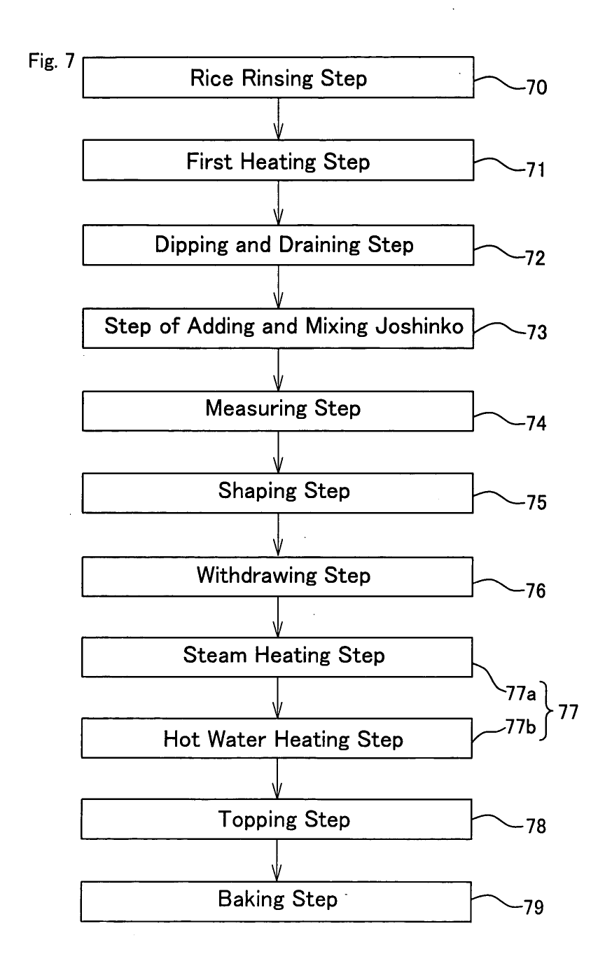

A rice pizza was produced by a process shown in FIG. 7 using 120 g of polished rice, Koshihikari from Ibaraki. A rice rinsing step 70, a first heating step 71, a dipping and draining step 72, a step 73 of adding and mixing joshinko, a measuring step 74, a shaping step 75, a withdrawing step 76, and a steam heating step 77a and a hot water heating step 77b of a second heating step 77 were performed in the same manner as the rice rinsing step 41, the first heating step 42, the dipping and draining step 43, the step 44 of adding and mixing joshinko, the measuring step 45, the shaping step 46, the withdrawing step 47, and the steam heating step 48a and the hot water heating step 48b of the second heating step 48 in Example 4 to produce a rice sheet.

In a topping step 78, pizza sauce was sprinkled on the upper surface of the rice sheet, and favorite ingredients such as cheese, salami and a green pepper were topped thereon. In a baking step 79, the topped rice sheet was put in an oven heated at 240° C., and baked for approximately 10 minutes until appropriate scorch was given to the surface. Consequently, a crispy rice pizza having a mouthfeel similar to that of a snack was obtained.

### EXAMPLE 7

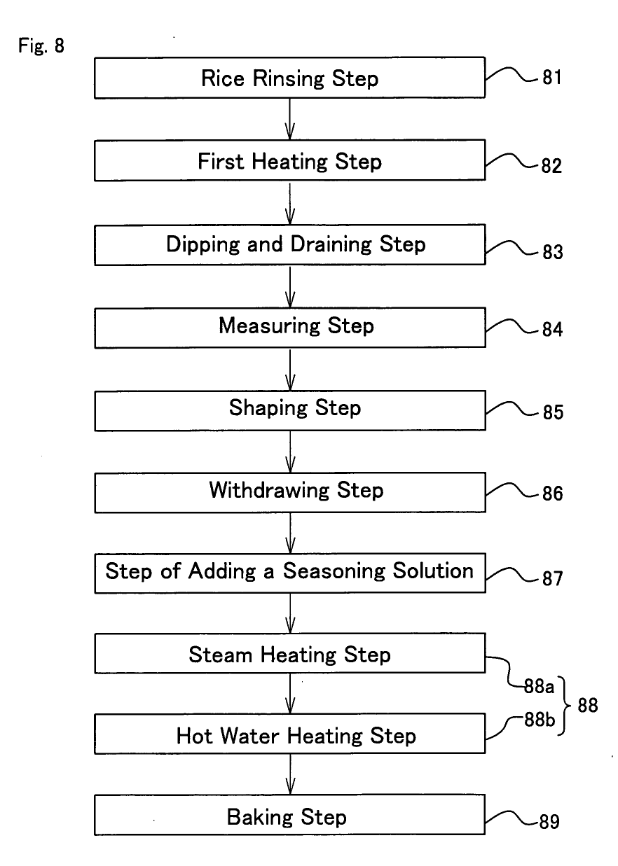

Rice dough for rice mille-feuille was produced by a process shown in FIG. 8 using 120 g of polished rice, Koshihikari from Ibaraki. A rice rinsing step 81, a first heating step 82, a dipping and draining step 83, a measuring step 84, a shaping step 85 and a withdrawing step 86 were performed in the same manner as the rice rinsing step 11, the first heating step 12, the dipping and draining step 13, the measuring step 14, the shaping step 15 and the withdrawing step 16 in Example 1 to produce a surface-gelatinized rice sheet.

In a step 87 of adding a seasoning solution, 60 ml of strong soy sauce, 30 ml of sake and 10 g of joshinko were mixed to make the seasoning solution, and both sides of the surface-gelatinized rice sheet were coated with the seasoning solution by a brush.

In a steam heating step 88a of a second heating step 88, the surface-gelatinized rice sheet put on a net made of a fluororesin was placed in a home steamer, and steamed for 35 minutes. Simultaneously, a hot water heating step 88b was performed, the surface-gelatinized rice sheet was steamed while the seasoning solution was sprinkled at several minutes intervals, and inverted as required during this step.

In a baking step 89, both sides of the rice sheet containing the seasoning solution were baked on a hot plate heated at 240° C. with sesame oil thin-coated thereon for approximately 2 minutes each. Consequently, rice dough for rice mille-feuille with a crispy mouthfeel having a weight of 43 g, a thickness of 5 mm and a diameter of approximately 115 mm after baking was obtained.

A rice mille-feuille is formed of, for example, seven layers. The rice dough is laid on the 1 st, 3rd, 5th and 7th layers, and ingredients are put on the 2nd, 4th and 6th layers. As the ingredients, soboro (sugared powder) of chicken meat, egg or the like, kinpira gobo (chopped burdock root cooked in soy sauce and sesame oil) and the like are used. The rice mille-feuille has a diameter of approximately 115 mm and a height of approximately 50 mm. This rice mille-feuille has a good flavor of boiled rice grains which was not found in the past and a crispy mouthfeel like that of a stack. Further, since each rice dough is good to chew, ingredients sandwiched between the layers are not pushed out of the side when chewing the rice mille-feuille. Thus, it can easily be eaten. As the seasoning solution, consommé or the like is also available. A western-style rice mille-feuille can also be prepared by sandwiching cheese, ham, marinier and the like.

In the foregoing Examples, the rice sheet after cooking is baked to make the rice pizza, the rice mille-feuille and the like. However, the invention is not limited to foods obtained by baking the rice sheet after cooking. The rice sheet after cooking can also be eaten. Since the rice sheet has appropriate strength and flexibility, it can also be eaten by winding or wrapping ingredients. Further, the rice sheet can be heated in a microwave oven. A gelling agent such as gelatin or a polysaccharide may be added to the surface-gelatinized rice or the surface-gelatinized rice sheet to increase bindability of rice grains of the rice sheet. When the rice sheet is seasoned, both sides of the surface-gelatinized rice sheet may be coated with the seasoning solution, or the seasoning solution is sprinkled on the surface-gelatinized rice sheet during the hot water heating step as described in the above Examples. In addition, a seasoning powder or foodstuffs may be added to the surface-gelatinized rice during the shaping step.

1. A process for producing a rice sheet, comprising a first heating step of heating raw rice with hot water or steam to obtain surface-gelatinized rice in which a surface layer portion is gelatinized and a central portion remains ungelatinized, a dipping and draining step of cooling the surface-gelatinized rice with water after the first heating step and then draining the resulting rice, a measuring step of measuring a weight of the surface-gelatinized rice for sectioning after the dipping and draining step, a shaping step of lightly kneading the surface-gelatinized rice sectioned in the measuring step and then shaping the resulting rice into a sheet, and a second heating step of cooking the surface-gelatinized rice sheet shaped in the shaping step.

2. The process for producing the rice sheet according to claim 1, wherein in the shaping step, starch is added to the surface-gelatinized rice.

3. The process for producing the rice sheet according to claim 1, wherein in the shaping step, a powdery seasoning or a foodstuff is added to the surface-gelatinized rice.

4. The process for producing the rice sheet according to claim 1, wherein the second heating step is performed by a steam heating step of heating the surface-gelatinized rice sheet with steam and a hot water heating step of heating the surface-gelatinized rice sheet with hot water after the steam heating step.

5. The process for producing the rice sheet according to claim 1, wherein the second heating step is performed by a steam heating step of heating the surface-gelatinized rice sheet with steam and a hot water heating step of heating the surface-gelatinized rice sheet during the steam heating step by sprinkling hot water.

6. The process for producing the rice sheet according to claim 4, wherein the hot water in the hot water heating step contains starch.

7. The process for producing the rice sheet according to claim 4, wherein the hot water in the hot water heating step contains a seasoning.

8. The process for producing the rice sheet according to claim 5, wherein the hot water in the hot water heating step contains starch.

9. The process for producing the rice sheet according to claim 5, wherein the hot water in the hot water heating step contains a seasoning.

10. The process for producing the rice sheet according to claim 1, further comprising a baking step of baking the surface of the rice sheet cooked in the second heating step.

11. The process for producing the rice sheet according to claim 10, wherein before the baking step, a topping step of topping ingredients or sauce on the upper surface of the rice sheet is performed.
